(19) United States
(12) Patent Application Publication
(10) Pub. No.: US 2026/0255341 A1
(43) Pub. Date: Aug. 27, 2026

(54) Method and wireless communication device for indicating a specified period in a wireless communication system

(71) Applicant: MEDIATEK INC., Hsinchu City (TW)

(72) Inventors: Hao-Hua Kang, Hsinchu City (TW); Chien-Fang Hsu, Hsinchu City (TW); Chih-Chun Kuo, Hsinchu City (TW); Cheng-Ying Wu, Hsinchu City (TW)

(73) Assignee: MEDIATEK INC., Hsinchu City (TW)

(21) Appl. No.: 19/531,691

(22) Filed: Feb. 6, 2026

Related U.S. Application Data
(60) Provisional application No. 63/761,224, filed on Feb. 21, 2025.

(51) Int. Cl. H04W 72/1263

(52) U.S. Cl. CPC H04W 72/1263

(57) ABSTRACT

A wireless communication method determines a start time of a specified period based on a minimum time interval. The start time is at least the minimum time interval after an end of transmission of an indication frame to be transmitted by a first wireless communication device. The specified period is a period during which the first wireless communication device will become unavailable, or will operate with modified settings for one or more operational parameters. The first wireless communication device transmits the indication frame to a second wireless communication device, where the indication frame carries information associated with the start time. A receiving device calculates a distance value based on the information and determines whether the start time falls within a valid interval or a past interval to avoid Timing Synchronization Function timestamp wrap-around issues.

### CROSS REFERENCE TO RELATED APPLICATIONS

This application claims the benefit of U.S. Provisional Application No. 63/761,224, filed on Feb. 21, 2025. The content of the application is incorporated herein by reference.

### BACKGROUND

The present disclosure relates generally to wireless communication systems, and more particularly to methods and apparatus for indicating the start time of a specified period (e.g., an unavailable period) in wireless communication systems.

In wireless communication systems, a wireless communication device may have limited transmission (TX) or reception (RX) capabilities during certain periods due to various reasons, including but not limited to in-device coexistence (IDC) issues, low power mode operations, or other operational constraints. These periods are referred to as unavailable windows or unavailable periods.

In some scenarios, a challenge may arise when a device desires to indicate an unavailable window that has already begun or will begin in a very short time. Specifically, a TSF timestamp wrap-around issue may occur when the receiving device processes the indication frame. This wrap-around issue can be caused by processing delays at the receiving device, or clock drift between devices. For example, according to IEEE 802.11 standards, the worst-case clock drift of each non-DMG STA is ±200 ppm (i.e., a worst-case relative drift of approximately 400 ppm between two STAs). Considering the cumulative drift between two devices (i.e., approximately 400 ppm in total) over a beacon interval of 100 TUs (where 1 TU=1024 microseconds), the resulting relative clock drift may be approximately 40.96 microseconds (i.e., 400×(100×1024)/1,000,000≈40.96 microseconds).

For example, if a receiving device starts processing the indication frame after the indicated beginning time has already passed, it may wrongly consider the indicated beginning time to be in the far future due to the wrap-around. This misinterpretation can cause communication disruptions and reduce system throughput.

### SUMMARY

According to an embodiment of the present disclosure, a method for wireless communication is provided. The method comprises: determining, by a first wireless communication device, a start time of a specified period based on a minimum time interval, such that the start time is at least the minimum time interval after an end of transmission of an indication frame to be transmitted by the first wireless communication device, wherein the specified period is a period during which the first wireless communication device will become unavailable, or during which the first wireless communication device will operate with modified settings for one or more operational parameters; and transmitting, by the first wireless communication device, the indication frame to a second wireless communication device, wherein the indication frame comprises information associated with the start time of the specified period.

According to another embodiment of the present disclosure, another method for wireless communication is provided. The method comprises: receiving, by a second wireless communication device, an indication frame from a first wireless communication device, wherein the indication frame comprises information associated with a start time of a specified period indicated by the first wireless communication device, and wherein the specified period is a period during which the first wireless communication device will become unavailable, or during which the first wireless communication device will operate with modified settings for one or more operational parameters; calculating, by the second wireless communication device, a distance value based on the information and a current timing synchronization function (TSF) timestamp of the second wireless communication device; determining, by the second wireless communication device based on the distance value, whether the start time falls within a valid interval or a past interval; and responsive to determining that the start time falls within the past interval, identifying, by the second wireless communication device, that the specified period has already begun.

According to another embodiment of the present disclosure, another wireless communication device is provided. The wireless communication device comprises a transceiver and a processor coupled to the transceiver. The processor is configured to receive an indication frame from a first wireless communication device via the transceiver. The indication frame comprises information associated with a start time of a specified period indicated by the first wireless communication device. The specified period is a period during which the first wireless communication device will become unavailable, or during which the first wireless communication device will operate with modified settings for one or more operational parameters. The processor is further configured to calculate a distance value based on the information and a current timing synchronization function (TSF) timestamp of the wireless communication device and determine, based on the distance value, whether the start time falls within a valid interval or a past interval. The processor is further configured to identify that the specified period has already begun in response to determining that the start time falls within the past interval.

These and other aspects of the present disclosure will be apparent to those of ordinary skill in the art after reading the following detailed description of the embodiments illustrated in the various figures and drawings.

### BRIEF DESCRIPTION OF THE DRAWINGS

FIG. 1 is a block diagram illustrating a communication system according to an embodiment of the present disclosure.

FIG. 2 is a block diagram illustrating a structure of an indication frame with a partial TSF timestamp according to an embodiment of the present disclosure.

FIG. 3 is a block diagram illustrating a structure of an indication frame with a full TSF timestamp according to an embodiment of the present disclosure.

FIG. 4 is a timing diagram illustrating a method for setting a start time of a specified period based on a minimum time interval according to an embodiment of the present disclosure.

FIG. 5 is a timing diagram illustrating a method for determining whether a start time falls within a valid interval A1, an invalid interval A2, or a past interval A3 based on a distance value D according to an embodiment of the present disclosure.

FIG. 6 is a timing diagram illustrating a clock drift scenario between wireless communication devices according to an embodiment of the present disclosure.

FIG. 7 is a timing diagram illustrating an offset-based method for indicating a start time of a specified period according to an embodiment of the present disclosure.

FIG. 8 is a timing diagram illustrating TSF timestamp relationships between wireless communication devices according to an embodiment of the present disclosure.

### DETAILED DESCRIPTION

The following description sets forth exemplary embodiments and does not limit the scope of the appended claims. Features described in connection with one embodiment may be combined with features of other embodiments. Reference throughout this specification to “one embodiment,” “an embodiment,” “certain embodiments,” or related phrases means that a particular feature, structure, or characteristic described in connection with the embodiment may be included in at least one embodiment. Thus, appearances of the phrases “in one embodiment,” “in an embodiment,” “in certain embodiments,” and related phrases throughout this specification may, but do not necessarily, all refer to the same embodiment.

The following detailed description refers to the accompanying drawings that show, by way of illustration, specific aspects and embodiments in which the present disclosure may be practiced. These embodiments are described in sufficient detail to enable those skilled in the art to practice the present disclosure. Other embodiments may be used, and structural, logical, and electrical changes may be made without departing from the scope of the present disclosure. The various embodiments disclosed herein are not necessarily mutually exclusive, as some disclosed embodiments may be combined with one or more other disclosed embodiments to form new embodiments.

According to the present disclosure, a number of possible solutions may be implemented separately or jointly. That is, although these possible solutions may be described below separately, two or more of these possible solutions may be implemented in one combination or another.

The following paragraphs define key terms used throughout this disclosure. Subsequent paragraphs describe embodiments and implementations in detail.

“Timing Synchronization Function” or “TSF” refers to a mechanism defined in IEEE 802.11 standards for synchronizing the clocks of wireless communication devices in a network. The TSF maintains a TSF timer, which is a timer measured in microseconds that provides a common time reference for devices in the network. In some embodiments, the TSF timer comprises a 64-bit counter that increments once per microsecond (μs). In other embodiments, the TSF timer may have a different bit width.

“Partial TSF timestamp” refers to a subset of bits extracted from a TSF timer value. The partial TSF timestamp is denoted as TSF[N1:N2], which represents bits from bit position N2 (i.e., N2-th bit) to bit position N1 (i.e., N1-th bit) of the TSF timer, where N1 and N2 are non-negative integers and N1 is greater than N2. The number of bits in the partial TSF timestamp is N=(N1−N2+1).

“Full TSF timestamp” refers to the complete TSF timer value, as opposed to a partial

TSF timestamp that includes only a subset of bits.

“Specified period” refers to a period during which a wireless communication device is unavailable, or operates with modified settings for one or more operational parameters, for example, having limited capability for at least one of transmission or reception. In some embodiments, the specified period may correspond to an “unavailable period” or “unavailable window”, where the wireless communication device will be unavailable. In other embodiments, the specified period may correspond to a parameter modification period, where the wireless communication device operates with modified settings for one or more operational parameters (e.g., bandwidth), e.g., due to limited capability for at least one of transmission or reception or other operational constraints. The methods disclosed herein are applicable to both periods, and the indication frame may be used to inform a peer device of the start time of the specified period regardless of whether the specified period involves unavailability, modified operational parameters (such as limited capability), or both.

“Limited capability” refers to a state in which a wireless communication device has reduced or constrained ability for transmission, reception, or both, compared to its normal operational state. A wireless communication device may have limited capability due to various reasons, including but not limited to in-device coexistence (IDC) issues, low power mode operations, hardware constraints, or other operational conditions.

A device may indicate its specified period (e.g., the unavailable window) to its peer device by transmitting indication frames. The indication frame may carry information about the beginning time and optionally the duration of the unavailable window, as well as other TX/RX capability constraints during the specified period (e.g., the unavailable window).

“Start time” refers to the beginning time of the specified period. In the embodiments, the start time may be indicated using a partial TSF timestamp, a full TSF timestamp, or an offset from a reference point.

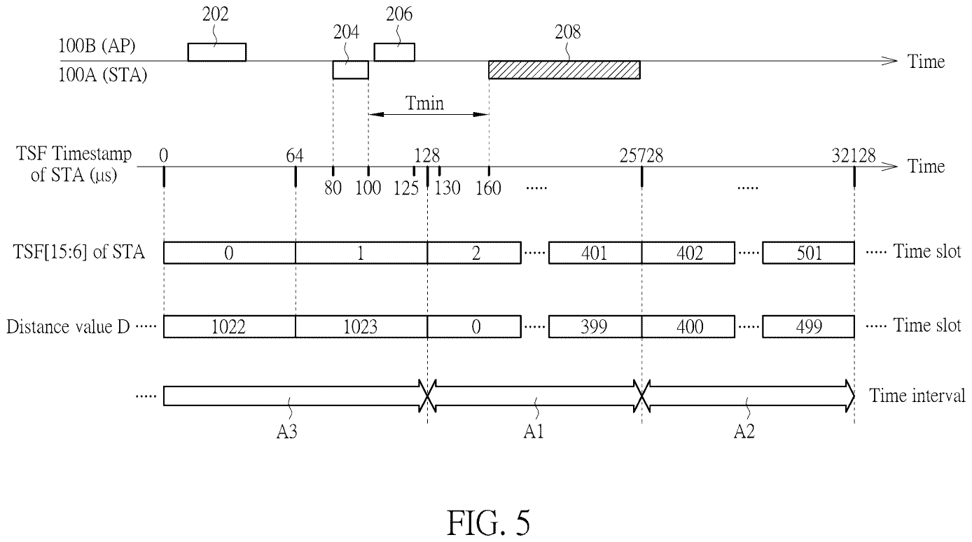

“Distance value” refers to a value calculated in a modular timestamp space to relate an indicated partial TSF timestamp to a current partial TSF timestamp of the peer device. In some embodiments, the distance value D is calculated as ((Indicated TSF[N1:N2]−Current TSF[N 1:N2]) mod 2^{N}). For example, taking N1=15 and N2=6 as an example, therefore N=(N1−N2+1)=10, resulting in a modulus value of 2¹⁰=1024. It should be noted that N1 and N2 in the invention are not limited to 15 and 6. The values 15 and 6 are merely examples for ease of illustration. For example, N1=15 and N2=7 or other cases are also possible. The distance value D may be used to determine whether an indicated start time falls within a valid interval, an invalid interval (optional), or a past interval, as described with respect to FIG. 5.

“Valid interval” refers to a range of distance values for which an indicated start time is treated as not having passed and reliable. “Past interval” refers to a range of distance values for which an indicated start time is treated as already passed. “Invalid interval” (optional) refers to a range of distance values for which timing information is treated as unreliable. Example actions associated with these intervals are described with respect to FIG. 5.

“Indication frame” refers to a frame transmitted by a wireless communication device to indicate the start time of its specified period to a peer device. Optionally, the duration of the specific period can also be indicated in the “Indication frame”. However, the focus of this invention is on indicating the start time of a specific period.

“Operational parameters” refers to configurable settings that affect the operation of a wireless communication device. The operational parameters may include, but are not limited to, transmission power settings, channel bandwidth configurations, modulation and coding scheme (MCS) settings, number of spatial streams, aggregation parameters (such as maximum Aggregated MAC Protocol Data Unit (A-MPDU) length or maximum Aggregated MAC Service Data Unit (A-MSDU) size), guard interval settings, beamforming configurations, multi-link operation parameters, power save parameters, or other parameters that affect the transmission or reception behavior of the wireless communication device. In some embodiments, the modified settings for operational parameters are pre-configured or pre-negotiated between the first wireless communication device and the second wireless communication device, such that the indication frame indicates the start time of the specified period without carrying the specific values of the modified operational parameters.

“Response frame” refers to a frame transmitted by a wireless communication device in response to receiving an indication frame from a peer device. In some embodiments, the response frame may be a Multi-Station Block Acknowledgement (MSBA) frame, an acknowledgement (ACK) frame, a Block Acknowledgement (BA) frame, or another suitable frame type that confirms receipt of the indication frame or provides feedback to the transmitting device.

“Announce frame” refers to a frame transmitted by a wireless communication device to announce operational parameters, such as the minimum time interval, to peer devices. The announce frame may be a beacon frame, a broadcast management frame, a unicast management frame, or another type of management frame that is received by at least one device in the network.

“Minimum time interval” or “Tmin” refers to the shortest specified time should be reserved from the end of the indication frame to the beginning of the specified period. The minimum time interval is defined based on a processing delay at the second wireless communication device and a clock drift between the first wireless communication device and the second wireless communication device. For example, the minimum time interval is provided from the peer device (such as the AP) or a default value.

“Current TSF timestamp” of a wireless communication device refers to the value of the TSF timer of that wireless communication device at the time of performing a particular operation, such as processing a received indication frame.

“Current partial TSF timestamp” refers to the partial TSF timestamp extracted from the current TSF timer value of a wireless communication device at the time of performing a particular operation. It is noted that “Current partial TSF timestamp” can be obtained from “Current TSF timestamp”.

“End of an indication frame” refers to completion of transmitting the indication frame. In some embodiments, the end of the indication frame corresponds to the end of transmission of the corresponding physical layer protocol data unit (PPDU) by the physical layer (PHY) of the first wireless communication device. In other embodiments, the end of the indication frame may be defined as another implementation-specific transmission completion time.

As used herein, the term “approximately” in connection with a numerical value refers to values within a tolerance range of the stated value. The tolerance range may be determined based on the context and the precision of measurement or calculation involved in the relevant technical field.

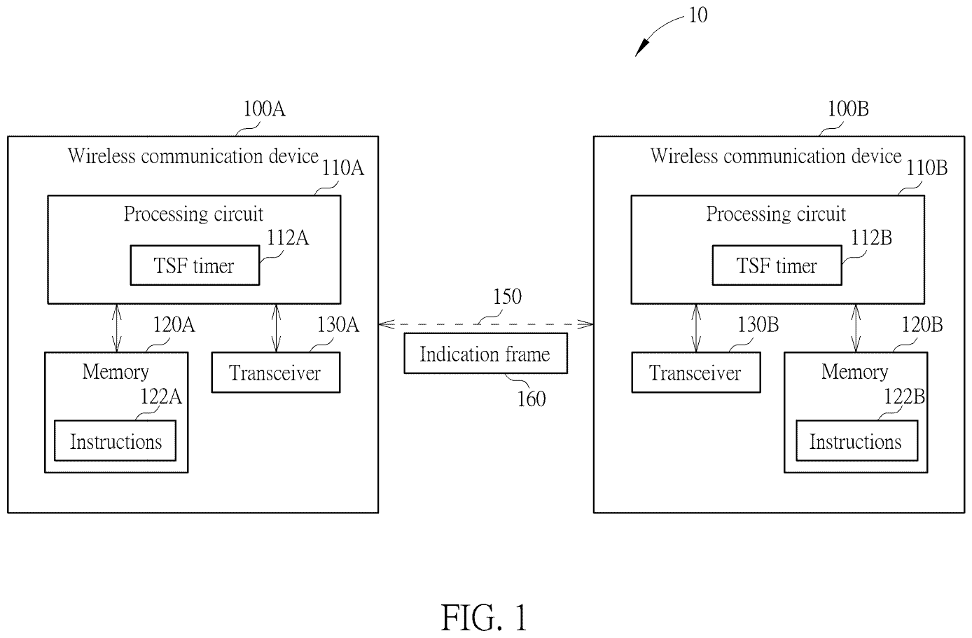

Referring to FIG. 1, an exemplary communication system 10 is depicted according to embodiments of the present disclosure. The communication system 10 comprises a wireless communication device 100A and a wireless communication device 100B. The wireless communication device 100A and the wireless communication device 100B communicate with each other via a wireless link 150. The wireless link 150 represents a communication channel between the wireless communication device 100A and the wireless communication device 100B over which wireless signals, including indication frames and response frames, are transmitted and received.

In some embodiments, the wireless communication device 100A may be a non-AP STA and the wireless communication device 100B may be an AP. In other embodiments, the wireless communication device 100A may be an AP and the wireless communication device 100B may be a non-AP STA. In other embodiments, the wireless communication device 100A may be a first multi-link device (MLD) and the wireless communication device 100B may be a second MLD. When multi-link devices are involved, the wireless communication device 100A and the wireless communication device 100B may communicate via multiple links simultaneously or alternatively, and the specified period indication methods disclosed herein may be applied to one or more of the multiple links. In some embodiments, the wireless communication device 100A and the wireless communication device 100B are wireless communication devices compliant with IEEE 802.11bn (Wi-Fi 8) or subsequent wireless communication standards.

The methods disclosed herein may be implemented in wireless communication devices that may operate under IEEE 802.11 standards, including IEEE 802.11be (Wi-Fi 7), IEEE 802.11bn (Wi-Fi 8), and other related amendments. In such implementations, the indication information may be carried in a management frame, a control frame, or a trigger-based frame. For example, the indication frame may be implemented by a Buffer Status Report Poll (BSRP) Trigger frame, a Buffer Status Report Poll Non-Trigger-Based (BSRP NTB) frame, or a Multi-Station Block Acknowledgement (MSBA) frame. The following embodiments use the BSRP frame as an example for illustration, but the invention is not limited thereto.

Each of the wireless communication devices 100A and 100B comprises a processing circuit 110A or 110B, respectively. The processing circuit 110A includes a TSF timer 112A, and the processing circuit 110B includes a TSF timer 112B. In some embodiments, the TSF timer 112A and the TSF timer 112B are each implemented as a hardware timer maintained by MAC circuitry, such as a free-running counter (e.g., a 64-bit register) driven by a local oscillator and incremented with a nominal 1-microsecond resolution. The TSF value may be readable via registers and optionally latched at transmit/receive events to provide a stable “current time” for partial-TSF extraction and distance-value computation. In some implementations, the TSF timer supports synchronization by applying an offset and/or correction based on received timing information (e.g., beacon-based updates), and in multi-link device embodiments the TSF may be shared across links or maintained per link with defined offsets relative to a common reference.

The processing circuit 110A or 110B in each wireless communication device may comprise one or more processors, microcontrollers, digital signal processors (DSPs), field-programmable gate arrays (FPGAs), application-specific integrated circuits (ASICs), or any combination thereof.

Each of the wireless communication devices 100A and 100B further comprises a memory 120A or 120B, respectively. The memory 120A or 120B may include volatile memory and/or non-volatile memory. The memory 120A stores instructions 122A, and the memory 120B stores instructions 122B. The instructions, when executed by the respective processing circuit, cause the wireless communication device to perform the methods described herein.

Each of the wireless communication devices 100A and 100B further comprises a transceiver 130A or 130B, respectively. The transceiver 130A or 130B is coupled to the processing circuit 110A or 110B and is configured to transmit and receive wireless signals over radio frequency (RF) channels. In some embodiments, the transceiver 130A/130B includes an RF front end and baseband circuitry. For example, the transmit path may include one or more transmit chains with frequency translation and power amplification, and the receive path may include one or more receive chains with low-noise amplification, channel selection filtering, and analog-to-digital conversion, with associated gain control and impairment compensation. The transceiver may interface with one or more antennas and may support single-input single-output (SISO) or multiple-input multiple-output (MIMO) operation (including multi-link operation in some embodiments), and the processing circuit may control the transceiver and exchange frames via registers, interrupts, and/or direct memory access (DMA)-backed buffers.

The wireless communication device 100A transmits an indication frame 160 to the wireless communication device 100B via the wireless link 150. The indication frame 160 comprises information associated with a start time of a specified period of the wireless communication device 100A. The indication frame 160 may be a management frame, a control frame, or a trigger-based frame carrying the specified period information, for example, the indication frame may be implemented by a BSRP frame or an MSBA frame. In some embodiments, the indication information may be carried in a control frame or a control subfield, for example within a trigger-based exchange or an acknowledgement-related exchange.

During the specified period of the wireless communication device 100A, the wireless communication device 100B is expected to adjust its transmission behavior toward the wireless communication device 100A accordingly. For example, the wireless communication device 100B may refrain from scheduling transmissions addressed to the wireless communication device 100A, or may transmit only frames that do not solicit a response from the wireless communication device 100A, or may apply/adapt corresponding operational parameters according to communication or agreement with the wireless communication device 100A. It should be noted that the focus of this invention is on indicating the start time of a specific period, in order to avoid the TSF timestamp wrap-around issue.

The methods disclosed herein are applicable to indicating the start time for both unavailability indication and parameter update indication. For example, when the wireless communication device 100A will be unavailable during a specified period (In this situation, the specified period can be regarded as an unavailable period or unavailable window), the indication frame 160 may inform the wireless communication device 100B of the start time so that the wireless communication device 100B can adjust its scheduling accordingly. For example, the wireless communication device 100B may refrain from scheduling transmissions addressed to the wireless communication device 100A, or may transmit only frames that do not solicit a response from the wireless communication device 100A. Alternatively or additionally, when the wireless communication device 100A will operate with modified operational parameters (e.g., limited TX/RX capability or parameter updates in other scenarios) during the specified period, the indication frame 160 may inform the wireless communication device 100B of the start time so that the wireless communication device 100B may apply/adapt corresponding operational parameters when communicating with the wireless communication device 100A. For example, the wireless communication device 100B may adjust corresponding transmission parameters or scheduling to accommodate the modified operational parameters of the wireless communication device 100A.

The methods and systems described herein are implemented using one or more processors executing computer-executable instructions stored in non-transitory computer-readable media. The specific combination of hardware and software components, and their particular configuration as described herein, provides technical advantages including reduced timing misinterpretation, decreased communication disruptions, and improved device coordination that may not be achievable through approaches that do not account for TSF timestamp wrap-around.

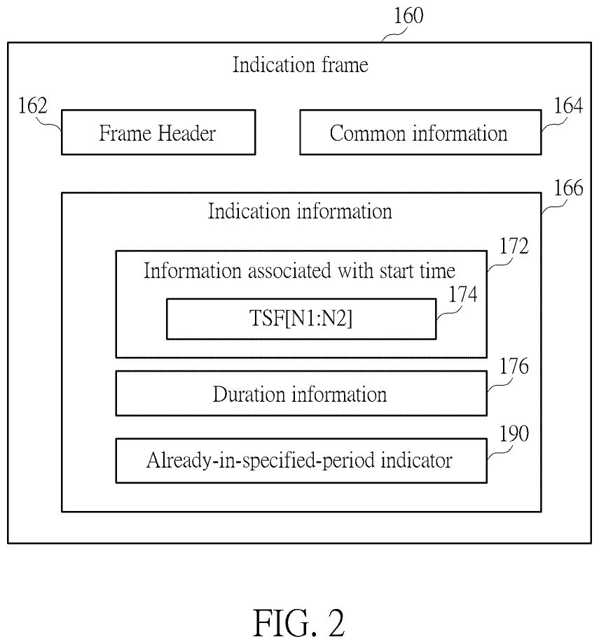

FIG. 2 illustrates an exemplary structure of an indication frame 160 with a partial TSF timestamp according to an embodiment of the present disclosure. The indication frame 160 comprises a frame header 162 and common information 164. The indication frame 160 further comprises indication information 166, the indication information at least comprises information associated with the start time 172, which is represented by a partial TSF timestamp 174 to reduce signaling overhead. The partial TSF timestamp 174 is labeled as TSF[N1:N2], which represents N bits from bit position N2 (i.e., N2-th bit) to bit position N1 (i.e., N1-th bit) of the TSF timer, where N1 and N2 are non-negative integers and N1 is greater than N2, wherein N=(N1−N2+1). The partial TSF timestamp may be defined for representing the start time with a certain granularity using a limited number of bits. Accordingly, the granularity of the partial TSF timestamp 174 is 2 to the power of N2 microseconds, because the TSF[N 1:N2] represents a binary value, where N2-th bit has a weight of 2 to the power of N2, that is, the weight of TSF[N1:N2] is 2^{N2}, which is common knowledge to those skilled in the art. In the embodiment of FIG. 2, the indication frame 160 includes the partial TSF timestamp 174 rather than a full TSF timestamp, and the start time has a granularity of 64 μs (microseconds). In other embodiments, the indication frame 160 may omit one or more of the optional fields shown in FIG. 2.

In some embodiments, N1 is 15 and N2 is 6, such that the partial TSF timestamp 174 comprises TSF[15:6], which is a 10-bit value, however the invention is not limited to this. Accordingly, the granularity of the partial TSF timestamp 174 is 2 to the power of N2 microseconds. When N2 is 6, the granularity is 2⁶=64 microseconds (μs). In other embodiments, N1 is 15 and N2 is 7, such that the partial TSF timestamp 174 comprises TSF[15:7], which is a 9-bit value. When N2 is 7, it is noted that the granularity should be 2⁷=128 microseconds, because the weight of TSF[15:7] is 2⁷, which is common knowledge to those skilled in the art. For ease of illustration and understanding, the following example uses N1=15 and N2=6 for demonstration purposes.

The partial TSF timestamp 174 indicates a time slot of granularity G=2^{N2} microseconds that contains the start time of the specified period. For example, when N2=6 and the granularity G=64 microseconds (μs), a partial TSF timestamp value of 0 may indicate that the start time falls within the time slot spanning 0 microseconds to 63 microseconds, a partial TSF timestamp value of 1 may indicate that the start time falls within the time slot spanning 64 microseconds to 127 microseconds, and a partial TSF timestamp value of 2 indicates that the start time falls within the time slot spanning 128 microseconds to 191 microseconds, etc. In some embodiments, the partial TSF timestamp identifies only a time slot (e.g., in units of 64 μs), not an exact start instant. In other words, the true start time of the specified period may occur anywhere within the indicated time slot, depending on the specific design of the wireless communication device 100A/100B. For example, the midpoint of the indicated time slot can be used as the true start time of the specified period. Similarly, the start/end point of the indicated time slot can be used as the true start time of the specified period. To prevent transmitting after the peer device becomes unavailable, the receiving device may apply a conservative rule as follows: (1) determine the time slot represented by the received partial TSF value, (2) treat the start of the time slot as the assumed start time, and (3) stop scheduling transmissions to the peer device starting from the start of the time slot. This rule may cause the receiving device to stop scheduling a little early, but it ensures that no transmission is scheduled after the peer device may have become unavailable.

The information associated with the start time 172 may further include duration information 176, which indicates a duration of the specified period. The duration information 176 may be expressed in units of 64 microseconds or other suitable units.

In one embodiment, the minimum time interval is defined to specify the minimum time that should be reserved between the end of the indication frame 160 and the beginning of the specified period. The minimum time interval may be defined based on a processing delay at the receiving device and a clock drift between the transmitting and receiving devices. For example, the minimum time interval can be a default value or announced by the AP.

In another embodiment, the indication frame 160 may further include an already-in-specified-period indicator 190 for indicating that the wireless communication device 100A is already in the specified period when the wireless communication device 100B processes the indication frame 160. Responsive to the already-in-specified-period indicator 190 being set, the wireless communication device 100B identifies that the wireless communication device 100A is already in the specified period without interpreting the start time or calculating the distance value.

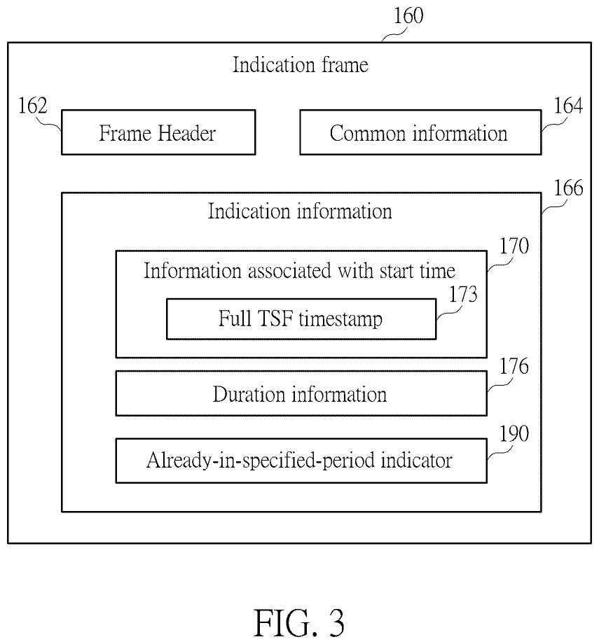

FIG. 3 illustrates an exemplary structure of an indication frame 160 with a full TSF timestamp according to an embodiment of the present disclosure. The indication frame 160 also comprises the frame header 162, the common information 164, and the indication information 166. Unlike the embodiment of FIG. 2 which uses a partial TSF timestamp 174, the embodiment of FIG. 3 uses a full TSF timestamp 173. The indication information 166 comprises information associated with the start time 170, and the information associated with the start time 170 contains the full TSF timestamp 173, which represents the complete TSF timer value.

In FIG. 3, the information associated with the start time 170 is represented by the full TSF timestamp 173, and the receiving device can determine the start time directly from the information associated with the start time 170 without calculating a distance value, thereby avoiding the wrap-around issue. However, this method will lead to heavy signaling overhead.

Similar to the embodiment of FIG. 2, the indication frame 160 in FIG. 3 may further include at least one of the duration information 176 and the already-in-specified-period indicator 190.

In embodiments where the specified period corresponds to a parameter modification period, the indication frame 160 may further comprise parameter modification information indicating the modified settings for one or more operational parameters. Alternatively, the modified settings may be pre-configured or pre-negotiated between the wireless communication device 100A and the wireless communication device 100B, such that the indication frame 160 may indicate only the start time of the specified period without carrying the specific values of the modified operational parameters. The receiving device applies the pre-configured or pre-negotiated modified settings starting from the indicated start time.

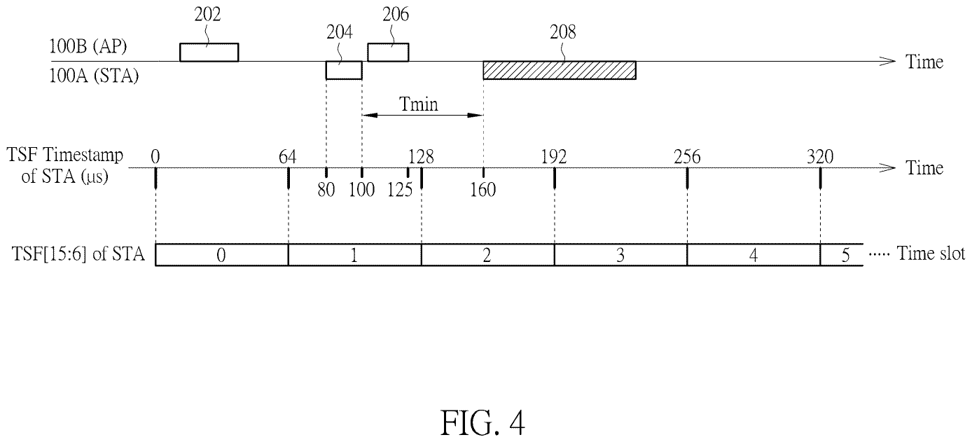

FIG. 4 illustrates a method for setting a start time of a specified period based on a minimum time interval according to an embodiment of the present disclosure. In the timing diagrams of FIG. 4 through FIG. 8, the indication frame is denoted as indication frame 204, which corresponds to an instance of the indication frame 160 described with respect to FIG. 1 through FIG. 3. In this method, the wireless communication device 100A sets the start time of its specified period 208 (e.g., an unavailable window) such that the start time is at least a minimum time interval (Tmin) after the end of the indication frame 204.

As shown in FIG. 4, the wireless communication device 100B (e.g., the AP) may transmit an announce frame 202 to announce the minimum time interval to the wireless communication device 100A (e.g., the non-AP STA). For example, the announce frame 202 may be a beacon frame or a broadcast management frame.

The wireless communication device 100A then may transmit an indication frame 204 (e.g., a BSRP frame) to indicate its upcoming specified period 208. In the example of FIG. 4, the indication frame 204 is transmitted starting at approximately 80 microseconds of the TSF timestamp of the STA and ends at approximately 100 microseconds. The wireless communication device 100B responds with a response frame 206 e.g., an MSBA frame). The response frame 206 is transmitted by the wireless communication device 100B to acknowledge receipt of the indication frame 204 and may carry additional feedback information. In the example of FIG. 4, the response frame 206 ends at approximately 125 microseconds.

As shown in FIG. 4, the minimum time interval Tmin is defined as 60 microseconds, starting from the end of the indication frame 204 (at approximately 100 microseconds). Thus, the start time of a specified period 208 is at least the minimum time interval Tmin after an end of transmission of the indication frame 204, as shown in FIG. 4, the beginning of a specified period 208 is constrained to be no earlier than 160 microseconds. In this example, the start time is indicated by Indicated TSF[15:6]=2.

The minimum time interval Tmin may be chosen to give the receiving device enough time to process the indication frame and to cover timing differences between devices (e.g., TSF clock drift or offset). In some cases, such timing differences can be larger, for example when a station does not receive beacons frequently during power-save operation and wakes at delivery traffic indication message (DTIM) intervals, or when multi-link operation introduces additional offset. In these cases, Tmin may be set with extra margin or longer.

By ensuring that the start time of the specified period 208 is at least the minimum time interval after the end of the indication frame 204, the receiving device has sufficient time to process the indication frame 204 before the specified period 208 begins, thereby avoiding misinterpretation due to the wrap-around issue.

In some embodiments, the minimum time interval Tmin is announced by the wireless communication device 100B to the wireless communication device 100A in a beacon frame or a broadcast management frame. In other embodiments, the minimum time interval is a predefined value stored at the wireless communication device 100A.

This minimum-time-interval rule makes the sender announce the specified period early enough, so the receiving device can finish processing the indication before the specified period begins and will not treat the start time incorrectly.

FIG. 5 illustrates a method for determining whether a start time falls within a valid interval or a past interval based on a distance value according to an embodiment of the present disclosure. This method defines the valid interval A1 and guard intervals, such as the invalid interval A2 (optional), and the past interval A3, to avoid the wrap-around issue when interpreting partial TSF timestamps.

As shown in FIG. 5, the wireless communication device 100B may announce the guard interval parameters to the wireless communication device 100A via an announce frame 202. The wireless communication device 100A transmits an indication frame 204 (such as a BSRP frame), and the wireless communication device 100B responds with a response frame 206 (such as an MSBA frame). The response frame 206 serves as an acknowledgement from the wireless communication device 100B to the wireless communication device 100A, confirming that the indication frame 204 has been received and processed. The wireless communication device 100A then enters a specified period 208.

In the example of FIG. 5, the indication frame 204 is transmitted starting at approximately 80 microseconds and ends at approximately 100 microseconds. The response frame 206 ends at approximately 125 microseconds. The specified period 208 begins at approximately 160 microseconds, which falls within time slot 2 (spanning 128 microseconds to 191 microseconds) of TSF[15:6]. The indication frame 204 indicates a start time with Indicated TSF[15:6]=2, representing that the start time is within time slot 2.

When the wireless communication device 100B receives the indication frame 204, it obtains an indicated partial TSF timestamp Indicated TSF[N1:N2] from the indication frame 204 and derives a current partial TSF timestamp Current TSF[N1:N2] from its TSF timer 112B. In some embodiments, Indicated TSF[N1:N2] corresponds to ((TSF_start >>N2) mod 2^{N}), where “>>N2” denotes a right-bit shift by N2 bits (i.e., an integer division by 2^{N} with the fractional portion discarded), TSF_start is an intended start time, and N=(N1−N2+1). The wireless communication device 100B may calculate a distance value: D=((Indicated TSF[N1:N2]−Current TSF[N1:N2]) mod 2^{N}).

In one example with N1=15 and N2=6 (N=10, modulus 1024), if Current TSF[15:6]=((TSF_current >>6) mod 1024)=2 and Indicated TSF[15:6]=2, then D=0. If Indicated TSF[15:6]=0 and Current TSF[15:6]=2, then D=((0−2) mod 1024)=1022. The modulo operation ensures that D falls within [0, 2^{N}−1] and correctly reflects wrap-around in the partial-TSF space.

Because the distance value D is computed using modulo arithmetic, the distance-value space is circular over [0, 2^{N}−1]. Accordingly, when the indicated partial TSF timestamp is slightly less than the current partial TSF timestamp, the subtraction may yield a negative value that becomes a large value close to (2^{N}−1) after the modulo operation. This wrap-around behavior enables distinguishing the valid interval A1 (smaller D values) from the past interval A3 (larger D values close to (2^{N}−1)), and FIG. 5 illustrates this relationship.

In FIG. 5, the horizontal axis “TSF[15:6] of STA” represents different possible values of the Indicated TSF[15:6] that the STA may specify as the start time of the specified period. The figure illustrates the resulting distance value D when the AP processes the indication frame at a fixed time (e.g., Current TSF[15:6]=2). This representation helps illustrate how the distance value D varies depending on the relative timing between the indicated start time (i.e., Indicated TSF[N1:N2]) and the AP's current time (i.e., Current TSF[N1:N2]).

Referring to FIG. 5, when using TSF[15:6] (N1=15, N2=6, N=10), the modulus value is 2¹⁰=1024, and the distance value D ranges from 0 to 1023. The figure shows the relationship between the Indicated TSF[15:6] (i.e., the start time indicated by the STA) and the corresponding distance value D when the AP processes the indication frame at Current TSF[15:6]=2. When the AP processes the indication frame 204 at TSF timestamp 130 microseconds (time slot 2, i.e., Current TSF[15:6]=2), and the Indicated TSF[15:6]=2, the distance value D=((2−2) mod 1024)=0, which indicates that the indicated start time corresponds to the current time of the AP.

As shown in FIG. 5, when the STA indicates a start time at time slot 401 (Indicated TSF[15:6]=401), and the AP processes the indication at time slot 2 (Current TSF[15:6]=2), the distance value D=((401−2) mod 1024)=399, which falls within the valid interval A1 (where 0≤D<400). Since D falls within the valid interval A1, the AP waits until the indicated start time before adjusting its behavior accordingly.

Conversely, as shown in FIG. 5, when the STA indicates a start time at time slot 0 (Indicated TSF[15:6]=0), and the AP processes the indication at time slot 2 (Current TSF[15:6]=2), the distance value D=((0−2) mod 1024)=1022, which falls within the past interval A3. Similarly, when the Indicated TSF[15:6]=1, the distance value D=((1−2) mod 1024)=1023. These large distance values indicate that, due to the wrap-around nature of the partial TSF timestamp, the indication should be treated as representing a past event. The AP identifies that the specified period 208 has already begun and may immediately adjust its behavior accordingly (e.g., refrains from scheduling transmission to the STA, or adjust transmission parameters).

As shown in FIG. 5, the time intervals are defined based on the distance value D and two preset threshold values, namely a first preset value and a second preset value, where the second preset value is greater than the first preset value. FIG. 5 depicts a valid interval A1, an invalid interval A2, and a past interval A3, such that the first preset value defines the boundary between the valid interval A1 and the invalid interval A2, and the second preset value defines the boundary between the invalid interval A2 and the past interval A3. In one example, when the first preset value is 400 and the second preset value is 500, the valid interval A1 corresponds to 0≤D<400, the invalid interval A2 corresponds to 400≤D<500, and the past interval A3 corresponds to D≥500. In another example, the first preset value may be 600 and the second preset value may be 800. The present disclosure does not impose any restrictions on the specific values of the first preset value and the second preset value.

When the wireless communication device 100B determines that the distance value D falls within the valid interval A1, the wireless communication device 100B waits until the indicated start time before adjusting its behavior accordingly. When the distance value D falls within the past interval A3, the wireless communication device 100B identifies that the specified period 208 has already begun, further, the wireless communication device 100B may immediately adjust its behavior accordingly.

When the distance value falls within the invalid interval A2, the wireless communication device 100B may take one of several actions. The invalid interval A2 indicates that the timing information may be unreliable because the indicated start time appears to have passed but is not clearly within the wrap-around range.

In a first approach, the wireless communication device 100B discards the indication frame 204 and does not update its scheduling behavior. The wireless communication device 100B continues with its previous scheduling state until a subsequent indication frame with valid timing information is received.

In a second approach, the wireless communication device 100B requests retransmission of the indication frame 204 from the wireless communication device 100A. The request may be explicit or implicit. An explicit request may be sent using a negative acknowledgement (NACK) frame, a retransmission request control frame, or a similar signaling message. An implicit request may be made by refraining from transmitting an expected response frame (e.g., an ACK frame or an MSBA frame) to the wireless communication device 100A. In response to an explicit request or in response to not receiving the expected response frame, the wireless communication device 100A retransmits the indication frame 204 or transmits a new indication frame with updated timing information. The wireless communication device 100B then recalculates the distance value based on the retransmitted indication frame and determines whether the new distance value falls within the valid interval A1, the invalid interval A2, or the past interval A3.

In a third approach, the wireless communication device 100B may treat the indication as falling within the past interval A3 and may immediately adjust its behavior accordingly toward the wireless communication device 100A. For example, the wireless communication device 100B may refrain from scheduling transmissions addressed to the wireless communication device 100A, or may transmit only frames that do not solicit a response from the wireless communication device 100A, or may apply transmission parameters in accordance with the agreement with the wireless communication device 100A. This approach reduces the likelihood of communication failure during the specified period 208, though it may result in unnecessary scheduling restrictions.

The choice of approach for handling the invalid interval A2 may depend on system design considerations, including latency tolerance, reliability requirements, and signaling overhead constraints. In some implementations, the approach may be configurable or may be selected dynamically based on network conditions.

The distance value D may be computed in the partial-TSF modular domain and compared with preset threshold values to classify the indicated start time into the valid interval A1, the invalid interval A2, or the past interval A3, as described with respect to FIG. 5.

In another example, N1=15 and N2=7 (in unit of 128 μs), such that the partial TSF timestamp has N=9 bits, the modulus value is 2⁹=512, and the timestamp granularity is G=2⁷=128 microseconds. In this 9-bit example, the first preset value may be 400 and the second preset value may be 500, such that distance values from 0 to 399 fall within the valid interval, distance values from 400 to 499 fall within the invalid interval, and distance values from 500 to 511 fall within the past interval. These values are examples, and other threshold values may be selected based on implementation-specific latency, drift, and margin considerations.

The first preset value and the second preset value may be selected based on the timestamp granularity G, an expected processing latency at the receiving device, an expected clock drift between devices, and a design safety margin, such that the past interval covers at least a range of distance values corresponding to the processing latency, the clock drift, and a margin relative to the granularity.

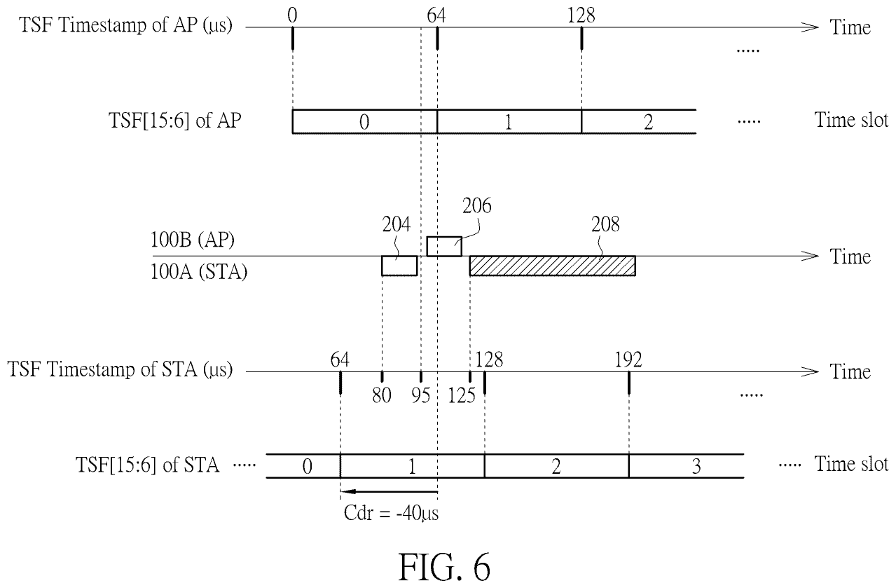

FIG. 6 illustrates an embodiment in which the wireless communication device 100A includes a full TSF timestamp 173 in the indication frame 160, rather than using only a partial TSF timestamp 174, to indicate the start time of the specified period 208. The full TSF timestamp 173 represents the complete TSF timer value corresponding to the start time of the specified period 208, thereby avoiding ambiguity that may arise from wrap-around when only a partial TSF timestamp is used.

FIG. 6 also illustrates a clock drift scenario between wireless communication devices. Due to a clock drift (Cdr) between the TSF timer 112A of the wireless communication device 100A and the TSF timer 112B of the wireless communication device 100B, the same absolute time corresponds to different TSF timestamp values at each device. As shown in FIG. 6, the clock drift is Cdr=−40 microseconds between the AP and the STA: the AP TSF time slots 0, 1, and 2 start at approximately 0 microseconds, 64 microseconds, and 128 microseconds, while the STA's TSF timeline shows corresponding times at approximately 64 microseconds, 80 microseconds, 95 microseconds, 125 microseconds, 128 microseconds, and 192 microseconds. In this example, the wireless communication device 100A transmits an indication frame 204 at approximately 80 microseconds (STA time). Due to inter-device clock drift and processing latency, the wireless communication device 100B begins processing the indication frame 204 at approximately 95 microseconds (STA time). The wireless communication device 100B transmits a response frame 206 acknowledging receipt of the indication frame 204, and the specified period 208 begins at approximately 125 microseconds (STA time), which corresponds to time slot 1 of the STA.

When the wireless communication device 100B receives the indication frame 160 carrying the full TSF timestamp 173, the wireless communication device 100B may determine the start time directly from the full TSF timestamp 173 without calculating a distance value in the partial-TSF modular space. Alternatively, for implementations that reuse partial-TSF logic, the wireless communication device 100B may extract TSF[N1:N2] from the full TSF timestamp 173 and process the extracted value in a manner consistent with partial-TSF processing. In either case, carrying the full TSF timestamp 173 helps prevent misinterpretation of the start time that could otherwise occur due to processing delay and/or inter-device clock drift when only a partial TSF timestamp is provided.

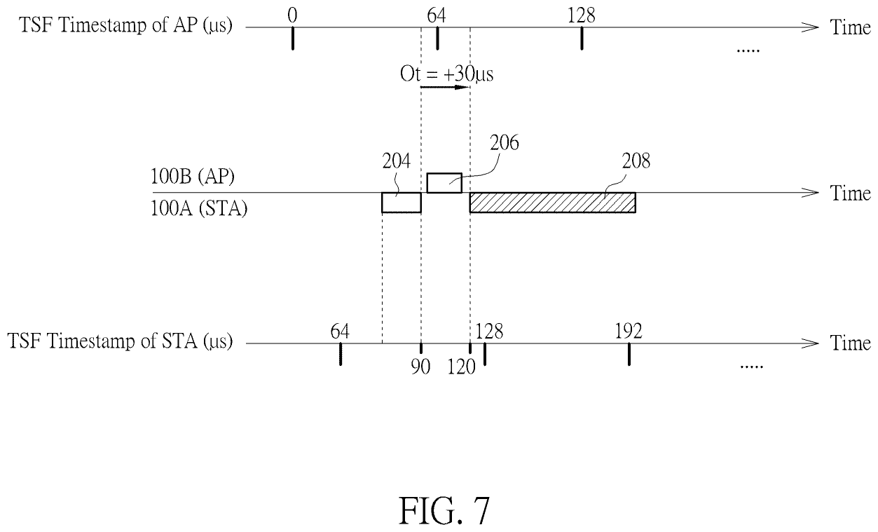

FIG. 7 illustrates an offset-based method for indicating a start time of a specified period 208 according to an embodiment of the present disclosure. In this method, the wireless communication device 100A indicates an offset Ot from a reference point rather than an absolute TSF timestamp.

As shown in FIG. 7, the TSF timestamp of the AP shows 0 microseconds, 64 microseconds, and 128 microseconds. The TSF timestamp of the STA shows 64 microseconds, 90 microseconds, 120 microseconds, 128 microseconds, and 192 microseconds. The wireless communication device 100A transmits an indication frame 204 ending at approximately 90 microseconds (STA time). The wireless communication device 100B responds with a response frame 206, acknowledging the indication frame 204. The offset Ot=+30 microseconds indicates that a specified period 208 will begin 30 microseconds after the end of the indication frame 204.

The reference point (also referred to as an anchor time) may be defined as the time at which transmission of the indication frame 204 is completed. In the example of FIG. 7, the indication frame 204 completes transmission at approximately 90 microseconds, and the offset Ot=+30 microseconds indicates that the specified period 208 is to begin approximately 30 microseconds after this anchor time, i.e., at approximately 120 microseconds. The wireless communication device 100A enters the specified period 208 at that time. When the wireless communication device 100B receives the indication frame 204, it calculates the start time of the specified period 208 by adding the offset to the reference point. The offset-based method avoids the wrap-around issue because the offset value represents a relative time difference rather than an absolute TSF timestamp value that may wrap around.

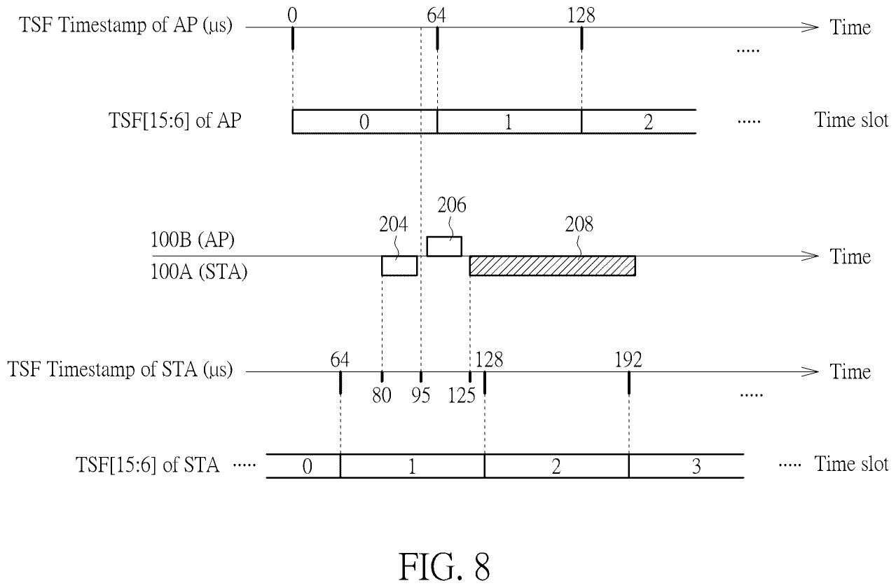

FIG. 8 shows an embodiment in which the transmitting device sets an already-in-specified-period indicator 190 in the indication frame 204 to explicitly tell the receiving device that the transmitting device is already in the specified period when the indication frame 204 is sent. FIG. 8 also illustrates that the AP and the STA may not share the same TSF timing at a given moment and that the receiving device may process the indication frame later than the transmitting time. Accordingly, if only a partial TSF timestamp is used, the receiving device may associate it with an incorrect time slot.

As shown in FIG. 8, the AP TSF timeline includes time-slot boundaries at approximately 0 microseconds, 64 microseconds, and 128 microseconds, while the STA TSF timeline is offset such that corresponding boundaries appear at approximately 64 microseconds, 128 microseconds, and 192 microseconds. In this example, the STA transmits the indication frame 204 at approximately 80 microseconds (STA time). Due to the TSF offset and processing delay, the AP begins processing the indication frame 204 at approximately 95 microseconds (STA time), and subsequently transmits a response frame 206 acknowledging receipt of the indication frame 204.

In this embodiment, instead of requiring the AP to determine whether the indicated start time is in the past or the future based on the partial TSF timestamp, the already-in-specified-period indicator 190 provides an explicit indication that the specified period has already begun when the indication frame 204 is transmitted. Responsive to the already-in-specified-period indicator 190 being set, the AP treats the STA as currently in the specified period and adjusts its behavior accordingly toward the STA (e.g., refrains from scheduling transmissions to the STA when the STA has limited capability, or adjusts transmission parameters when the STA operates with modified operational parameters) without performing distance-value computation or other start-time interpretation based on the partial TSF timestamp.

Although specific embodiments have been described, various combinations of features from different embodiments are contemplated. For example, features described with respect to one embodiment may be combined with features described with respect to other embodiments. Such combinations are within the scope of the present disclosure.

In one approach, the transmitting device constrains the start time of a specified period so that it occurs no earlier than a minimum interval after transmission of the indication frame is completed. This ensures the receiving device has enough time to handle the indication before the specified period begins, which reduces misinterpretation caused by processing delay and inter-device TSF offset and helps avoid transmissions that overlap the specified period. In another approach, the receiving device computes a distance value from the indicated partial TSF timestamp and its current TSF timing using modulo arithmetic to handle wrap-around. The receiving device then applies preset thresholds to decide whether the start time is in the future, in a guard range, or already in the past, and takes a corresponding action. The distance-value computation with threshold-based classification reduces start-time errors caused by partial-TSF wrap-around.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for wireless communication, the method comprising:
determining, by a first wireless communication device, a start time of a specified period based on a minimum time interval, such that the start time is at least the minimum time interval after an end of transmission of an indication frame to be transmitted by the first wireless communication device, wherein the specified period is a period during which the first wireless communication device will become unavailable, or during which the first wireless communication device will operate with modified settings for one or more operational parameters; and
transmitting, by the first wireless communication device, the indication frame to a second wireless communication device, wherein the indication frame comprises information associated with the start time of the specified period.

2. The method of claim 1, wherein the start time has a granularity of 64 μs, and the indication frame further comprises a duration of the specified period.

3. The method of claim 1, wherein the start time has a granularity of 64 μs, the information associated with the start time comprises a partial timing synchronization function (TSF) timestamp, and the partial TSF timestamp comprises N bits from bit position N2 to bit position N1 of a TSF timer, where N1 and N2 are non-negative integers, N1 is greater than N2, and N=(N1−N2+1).

4. The method of claim 1, wherein the indication frame is implemented by a Buffer Status Report Poll (BSRP) frame or a Multi-Station Block Acknowledgement (MSBA) frame.

5. The method of claim 1, wherein the indication frame further comprises an already-in-specified-period indicator indicating that the first wireless communication device is already in the specified period when the second wireless communication device processes the indication frame.

6. The method of claim 1, wherein the minimum time interval is a default value or is defined based on a processing delay at the second wireless communication device and a clock drift between the first wireless communication device and the second wireless communication device.

7. A method for wireless communication, the method comprising:
receiving, by a second wireless communication device, an indication frame from a first wireless communication device, wherein the indication frame comprises information associated with a start time of a specified period indicated by the first wireless communication device, and wherein the specified period is a period during which the first wireless communication device will become unavailable, or during which the first wireless communication device will operate with modified settings for one or more operational parameters;
calculating, by the second wireless communication device, a distance value based on the information associated with the start time and a current timing synchronization function (TSF) timestamp of the second wireless communication device;
determining, by the second wireless communication device based on the distance value, whether the start time falls within a valid interval or a past interval; and
responsive to determining that the start time falls within the past interval, identifying, by the second wireless communication device, that the specified period has already begun.

8. The method of claim 7, wherein the information associated with the start time comprises a partial timing synchronization function (TSF) timestamp, and wherein calculating the distance value comprises:
determining a difference between the partial TSF timestamp indicated in the indication frame and a current partial TSF timestamp of the second wireless communication device; and
calculating a remainder of the difference modulo a modulus value.

9. The method of claim 8, wherein the start time has a granularity of 64 μs, the partial TSF timestamp comprises N bits from bit position N2 to bit position N1 of a TSF timer, where N1 and N2 are non-negative integers and N1 is greater than N2, and wherein the modulus value is 2 to the power of N, where N is equal to (N1 minus N 2 plus 1).

10. The method of claim 7, wherein the valid interval corresponds to distance values that are greater than or equal to zero and less than a first preset value, the past interval corresponds to distance values that are greater than or equal to a second preset value, and the second preset value is greater than or equal to the first preset value.

11. The method of claim 10, further comprising:
responsive to determining that the start time falls within the valid interval, waiting until the start time before adjusting transmission behavior toward the first wireless communication device.

12. The method of claim 10, further comprising:
determining, by the second wireless communication device based on the distance value, whether the start time falls within an invalid interval corresponding to distance values that are greater than or equal to the first preset value and less than the second preset value; and
responsive to determining that the start time falls within the invalid interval, ignoring the indication frame or requesting retransmission of the indication frame.

13. The method of claim 7, wherein the start time has a granularity of 64 μs, the indication frame further comprises a duration of the specified period, and the indication frame is implemented by a Buffer Status Report Poll (BSRP) frame or a Multi-Station Block Acknowledgement (MSBA) frame.

14. The method of claim 7, wherein the indication frame further comprises an already-in-specified-period indicator, and wherein responsive to the already-in-specified-period indicator being set, the second wireless communication device identifies that the first wireless communication device is already in the specified period.

15. A wireless communication device, comprising:
a transceiver; and
a processor coupled to the transceiver, wherein the processor is configured to:
receive, via the transceiver, an indication frame from a first wireless communication device, wherein the indication frame comprises information associated with a start time of a specified period indicated by the first wireless communication device, and wherein the specified period is a period during which the first wireless communication device will become unavailable, or during which the first wireless communication device will operate with modified settings for one or more operational parameters;
calculate a distance value based on the information associated with the start time and a current timing synchronization function (TSF) timestamp of the wireless communication device;
determine, based on the distance value, whether the start time falls within a valid interval or a past interval; and
responsive to determining that the start time falls within the past interval, identify that the specified period has already begun.

16. The wireless communication device of claim 15, wherein the information associated with the start time comprises a partial timing synchronization function (TSF) timestamp, and wherein the processor is configured to calculate the distance value by:
determining a difference between the partial TSF timestamp indicated in the indication frame and a current partial TSF timestamp of the wireless communication device; and
calculating a remainder of the difference modulo a modulus value.

17. The wireless communication device of claim 16, wherein the start time has a granularity of 64 μs, the partial TSF timestamp comprises N bits from bit position N2 to bit position N1 of a TSF timer, where N1 and N2 are non-negative integers and N1 is greater than N2, and wherein the modulus value is 2 to the power of N, where N is equal to (N1 minus N 2 plus 1).

18. The wireless communication device of claim 15, wherein the valid interval corresponds to distance values that are greater than or equal to zero and less than a first preset value, and wherein the past interval corresponds to distance values that are greater than or equal to a second preset value, and the second preset value is greater than or equal to the first preset value.

19. The wireless communication device of claim 18, wherein the processor is further configured to:
responsive to determining that the start time falls within the valid interval, wait until the start time before adjusting transmission behavior toward the first wireless communication device.

20. The wireless communication device of claim 15, wherein the start time has a granularity of 64 μs, the indication frame further comprises a duration of the specified period, and the indication frame is implemented by a Buffer Status Report Poll (BSRP) frame or a Multi-Station Block Acknowledgement (MSBA) frame.
